(19) United States
(12) Patent Application Publication
(10) Pub. No.: US 2014/0156502 A1
(43) Pub. Date: Jun. 5, 2014

(54) CONDUCTING A LOAN

(71) Applicant: CFPH, LLC, (US)

(72) Inventors: Anthony Orso, New York, NY (US); Jill Weinstein, New York, NY (US); Brett Katz, New York, NY (US); Michael Brown, New York, NY (US); Michael May, New York, NY (US); Patrick Quinn, New York, NY (US)

(21) Appl. No.: 13/836,227

(22) Filed: Mar. 15, 2013

Related U.S. Application Data
(60) Provisional application No. 61/733,405, filed on Dec. 4, 2012.

(51) Int. Cl. G06Q 40/02; G06Q 20/10

(52) U.S. Cl. CPC G06Q 40/025; G06Q 20/10
USPC 705/38

(57) ABSTRACT

Methods and systems are disclosed for conducting a loan, including a construction loan, and fully funding the loan at closing.

### CROSS REFERENCE TO RELATED APPLICATION

This application claims the benefit of U.S. provisional application No. 61/733,405 filed Dec. 4, 2012 to Anthony Orso, et al., which is hereby incorporated by reference herein in its entirety.

### FIELD

Some embodiments relate to loans.

### BACKGROUND

Lenders may provide loans to borrowers to finance activities, such as making improvements to and/or developing property, including real property.

### BRIEF DESCRIPTION OF THE FIGURES

FIG. 1 shows an example loan structure according to some embodiments;

FIG. 2 shows another example loan structure according to some embodiments;

FIG. 3 shows an example process by which loan proceeds may be disbursed/released to a borrower according to some embodiments;

FIG. 4 shows another example loan structure according to some embodiments;

FIG. 5 shows another example process by which loan proceeds may be disbursed/released to a borrower according to some embodiments; and

FIG. 6 shows another example loan structure according to some embodiments.

### DETAILED DESCRIPTION

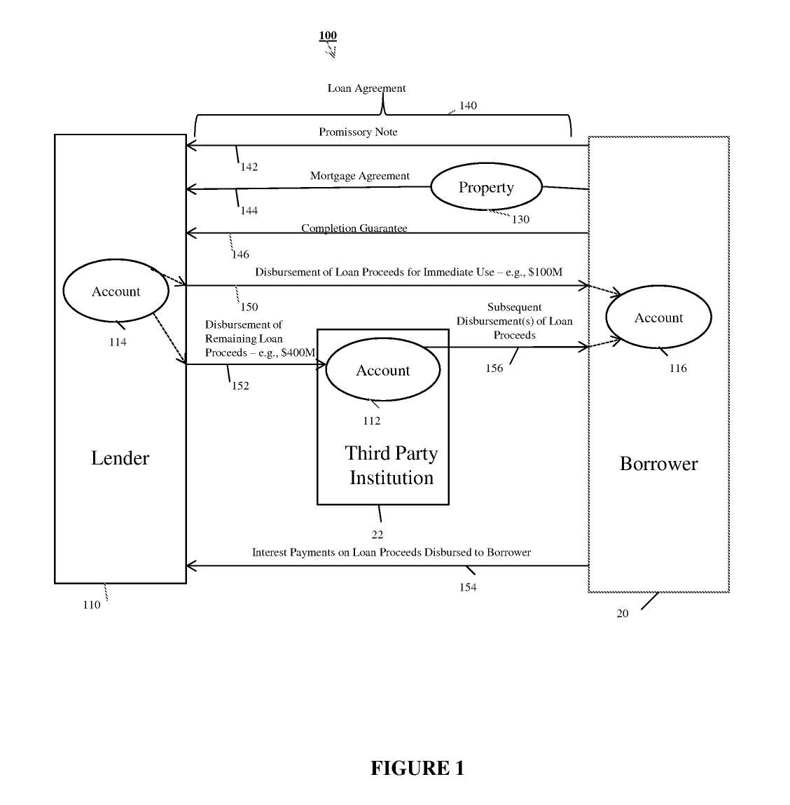

Referring to FIG. 1, there is shown an example loan structure 100, such as a construction loan, between multiple entities/parties, for example, such as lender 110 and borrower 20. Lender 110 may be a bank, a REIT (real estate investment trust), a non-bank institution, a fund, or any investment entity, etc. Borrower 20 may be any type of entity such as a corporation, limited liability company, partnership, etc. and in particular, may be a real estate developer, investor, etc. although other types of entities are possible. Borrower 20 may lease or own (partially or fully) property 130. Property 130 may be real property, such as one or more parcels of land, one or more structures (such as an office building, apartment building, commercial building, and/or factory, etc.), and/or a combination thereof. Borrower 20 may seek to demolish, improve, renovate and/or develop, etc. property 130. In order to finance such improvements, borrower 120 may seek to borrow funds from lender 110.

The funds borrower 20 seeks to borrow from lender 110 (or conversely, the funds lender 110 seeks to lend to borrower 20) may be referred to as loan proceeds and the amount of the funds/loan proceeds may be referred to as the principal amount or loan amount. For discussion purposes only herein, a loan amount of $500 million dollars ($500M) will be assumed. Nonetheless, loan structure 100 (in addition to the other example loan structures discussed herein) may apply to loans of lesser and/or greater amounts, and may apply to currencies in addition to and/or other than the U.S. dollar.

As shown in FIG. 1, lender 110 and borrower 20 may enter into a loan/loan agreement 140 in which borrower 20 may borrow $500M from lender 110 (and conversely, in which lender 110 may loan $500M to borrower 20). Such a loan agreement may be referred to as a construction loan agreement. As shown, loan agreement 140 may include several agreements (in paper and/or electronic form, for example) including, for example, one or more of promissory note 142, mortgage 144, and completion guarantee 146. Note 142 may be executed by borrower 20 and made payable to lender 110 in the amount of $500M, for example. Note 142 may include, for example, an interest rate(s) and also a payment schedule(s) that sets forth when interest payment(s) and repayment(s) of the loan amount are due as discussed herein. The loan may be secured with a lien and/or security interest in property 130 and improvements thereto through mortgage agreement 144, which may made by borrower 20 for the benefit of lender 110. Borrower 20 may also issue for the benefit of lender 110 completion guarantee 146 and perform thereunder. It should be understood that these example agreements are non-limiting, and that other agreements different from and/or in addition to one or more of the agreements discussed herein are possible.

According to one variation as may be set forth by loan agreement 140, lender 110 may not disburse the entire loan amount (e.g., $500M) to borrower 20 at closing (i.e., may not fully fund the loan at closing). For example, at closing lender 110 may initially disburse/release to borrower 20 none or only a portion of the loan amount (step 150), such as an initial amount of $100M, which loan proceeds may be immediately accessible/usable by borrower 20 (such loan proceeds may be referred to as the initial loan proceeds). Borrower 20 may use the initial loan proceeds to fund immediate improvement expenses to property 130, for example. Lender 110 may disburse/release these initial loan proceeds (step 150) to borrower 20 by authorizing the electronic transfer of/electronically transferring (e.g., wiring) the proceeds from one or more accounts 114 of the lender to one or more accounts 116 of borrower 20. Account 114 may be with lender 110 or some third party institution. Similarly, account 116 may be with some third party institution. Alternatively, lender 110 may disburse/release the initial loan proceeds to borrower 20 through one or more negotiable instruments (e.g., check). Other and/or additional means than those described herein may be used to disburse the initial loan proceeds to borrower 20, including any combination of the above.

In addition to the initial loan proceeds (which, as discussed, may be a zero amount) that lender 110 may disburse/release to borrower 20 at closing for immediate use, lender 20 may also establish (or have established by a third party institution 22) for the benefit of borrower 20 an account 112 (such as an escrow account), for example, and place/deposit therein the remaining loan amount, such as $400M (step 152) (such proceeds may be referred to as the remaining loan proceeds). Alternatively, from time to time lender 110 may fund/deposit into account 112 the remaining loan proceeds.

Regarding these remaining loan proceeds deposited in account 112, at one or more future times (e.g., after closing) such proceeds may be disbursed/released from this account to borrower 20 (step 156) (or conversely, drawn by borrower 20 from account 112) pursuant to loan agreement 140, or in other words, made accessible to/usable by borrower 20. These loan proceeds may be used by borrower 20 to fund additional improvement expenses, for example, to property 130 in a manner set forth in the loan agreement. Approval by lender 110 may be required before loan proceeds are released from account 112 (or in other words, loan proceeds may be released to borrower 20 at the direction of lender 110). One or more criteria and/or milestones may be used to determine when loan proceeds are disbursed/released from account 112 to borrower 20/made accessible to borrower 20. Lender 110 and/or third party institution 22 may disburse/release the loan proceeds to borrower 20 by electronically transferring (or authorizing the electronic transfer of) the proceeds from account 112 to one or more accounts 116 of borrower 20 and/or to one or more accounts of third parties (such as parties to which borrower 20 may owe a payment(s)). Alternatively, lender 110 and/or third party institution 22 may disburse/release the loan proceeds to borrower 20 through one or more negotiable instruments (e.g., check). As another example, the loan proceeds in account 112 may be released to borrower 20 without actually disbursing the proceeds but rather, by allowing borrower 20 to withdraw the released proceeds as needed. These examples are intended to be non-limiting and other and/or additional means than those described herein may be used to disburse loan proceeds to borrower 20 from account 112, including any combination of the above.

In accordance with loan agreement 140, borrower 20 may need to make one or more interest payments (e.g., electronically, through one or more negotiable instruments, etc.) to lender 110 until the loan amount is repaid. As one example, borrower 20 may pay to lender 20 interest payments on the loan proceeds disbursed/released to borrower 20 at closing (i.e., disbursement 150) and on the loan proceeds disbursed/released from account 112 (i.e., disbursement 156). These interest payment(s) are shown as payment(s) 154 in FIG. 1. However, borrower 20 may not be obligated to pay to lender 110 interest payments on the remaining loan proceeds in account 112, not yet disbursed/released to borrower 20. It should be noted that interest rate(s) associated with the payments discussed herein may either be floating and/or fixed interest rates.

Regarding the repayment of the loan amount as may be set forth by loan agreement 140, as one example, borrower 20 may not be obligated to begin repayment of the loan amount until the entire loan amount has been disbursed to the borrower, including the disbursement of all loan proceeds from account 112. As another example, borrower 20 may not be obligated to begin repayment of the loan amount until borrower 20 meets a certain milestone/criteria. Such repayments may begin even though all loan proceeds have not been disbursed from account 112. It should be understood that these examples are non-limiting, and additional and/or other structures may be used for repayment of the loan amount.

According to a further aspect, lender 110 may sell the payment streams associated with interest payments 154. Lender 110 may also securitize the loan to borrower 20. For example, lender 110 may issue (directly, or indirectly) (privately or publicly or any combination thereof) securities and/or other financial instruments to investors, which securities/instruments may be backed by/secured by mortgage 144. One skilled in the art will recognize that the loan to borrow 20 may be pooled with one or more additional assets including loans, for example, before being securitized. The issued securities/instruments may include debt securities, such as bonds. In general, such securities/instruments may be classified as mortgage backed securities. One skilled in the art will recognize that the loan may be securitized as any type of mortgage backed security. According to loan structure 100, lender 110 may be only able to securitize that portion of the loan that has been disbursed to borrower 20 (i.e., disbursements 150 and 156). Accordingly, in order to securitize the entire loan, lender 110 may be required to either do multiple securitizations as loan proceeds are disbursed, which may be overly cumbersome, or defer securitizing the loan until all disbursements have been made.

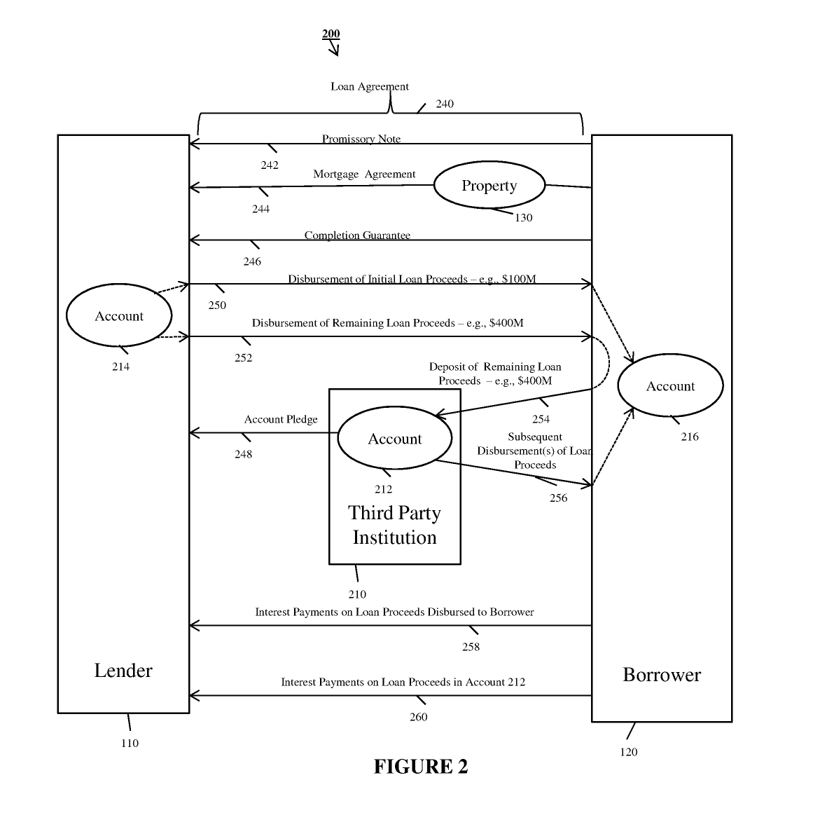

Referring to FIG. 2, there is shown another example loan structure 200, such as a construction loan, between multiple entities/parties, for example, such as lender 110 and borrower 120. Borrower 120 may be any type of entity such as a corporation, limited liability company, partnership, etc. and in particular, may be a real estate developer, investor, etc, for example, although other types of entities are possible. Borrower 120 may lease or own (partially or fully) property 130, may seek to improve and/or develop property 130, and may seek to borrow funds from lender 110 in order to finance such improvements. As another example, borrower 120 may be a sub-entity of a parent entity (not shown in FIG. 2) that seeks to improve and/or develop property 130, and that may seek to borrow funds from lender 110 in order to finance such improvements. Here, the parent entity may create/use borrower 120 for the purpose of entering into a loan agreement with lender 110, and for the purpose of improving/developing property 130. In this latter example, borrower 120 may own property 130 and be responsible for improvements to/development of property 130 including, for example, hiring all contractors necessary for improvement/development of property 130. As an example, borrower 120 may be a new entity, newly formed by the parent entity for purposes of loan structure 200. Borrower 120 may be a special purpose entity (SPE) and may be structured by the parent entity as a limited liability company that may be disregarded for tax purposes as an entity distinct from the parent entity. It should be understood that these examples of borrower 120's structure are non-limiting, and additional and/or other structures may be used.

As shown in FIG. 2, lender 110 and borrower 120 may enter into a loan/loan agreement 240 in which borrower 120 may borrow a loan amount—e.g., $500M, from lender 110 (or conversely, in which lender 110 may loan $500M to borrower 120). Such a loan agreement may be referred to as a construction loan agreement. According to one variation and as may be set forth by loan agreement 240, lender 110 may fully fund the loan at closing, for example, disbursing/releasing the entire loan amount of $500M to borrower 120 at closing. However, borrower 120 may not have immediate access to/may not be able to immediately use any of or all of the loan proceeds. For example, lender 110 may disburse/release to borrower 120 at closing a portion of the loan amount (step 250), such as an initial amount of $100M, which loan proceeds may be immediately accessible to/usable by borrower 120 (such proceeds may be referred to as the initial loan proceeds). Borrower 120 may use the initial loan proceeds to fund improvement/development expenses to property 130, for example. Lender 110 may disburse/release the initial loan proceeds to borrower 120 by authorizing the electronic transfer of/electronically transferring (e.g., wiring) the proceeds from one or more accounts 214 of the lender to one or more accounts 216 of borrower 120. Account 214 may be with lender 110 or some third party institution. Similarly, account 216 may be with some third party institution. Alternatively, lender 110 may disburse/release the initial loan proceeds to borrower 120 through one or more negotiable instruments (e.g., check). It should be understood that these examples are non-limiting and other and/or additional means than those described herein may be used to disburse the initial loan proceeds to borrower 120, including any combination of the above. As another example, rather than lender 110 disbursing/releasing to borrower 120 at closing a portion of the loan amount, lender 110 may disburse/release to borrower 120 at closing none of the loan amount for immediate use by borrower 120.

In addition to the initial loan proceeds (which, as discussed, may be a zero amount) that lender 110 may disburse/release to borrower 120 at closing for immediate use, lender 110 may also disburse/release to borrower 120 at closing the remaining loan amount, such as $400M (step 252), which loan proceeds may not be immediately accessible to/used by the borrower (such proceeds may be referred to as the remaining loan proceeds). Rather, borrower 120 may be required to place/deposit (or have placed/deposited), for example, the remaining loan proceeds into an account 212 (step 254). Again, lender 110 may disburse/release the remaining loan proceeds to borrower 120 by authorizing the electronic transfer of/electronically transferring (e.g., wiring) the proceeds from one or more accounts 214 of the lender to account 212, or by authorizing the electronic transfer of/electronically transferring the proceeds from one or more accounts 214 to one or more accounts 216 of borrower 120. In the latter case, borrower 120 may be required, once receiving the proceeds, to deposit the proceeds (e.g., by authorizing an electronic transfer or by depositing a negotiable instrument) into account 212 (step 254). As another example, lender 110 may disburse/release the remaining loan proceeds to borrower 120 through one or more negotiable instruments (e.g., check), which proceeds borrower 120 may be then required to deposit into account 212. It should be understood that these examples are non-limiting and other and/or additional means than those described herein may be used to disburse the remaining loan proceeds to borrower 120, including any combination of the above.

Account 212 may be referred to herein as a construction funding account. Account 212 may be, for example, a cash account or in particular, a cash collateral account, although other types of accounts may be used such as, for example, a tri-party repo, a master trust, etc. Account 212 may be with lender 110 and/or with some third party institution 210. Borrower 120 may own account 212 and be responsible for maintaining the account. Account 212 may be a pre-existing account (i.e., account existing before lender 110 and borrower 120 entered negotiations to loan/borrower funds), an account borrower 120 creates specifically for the purpose of loan agreement 240, may only have deposited therein the remaining loan proceeds and/or funds related to loan agreement 240, may have funds deposited therein not related to loan agreement 240, may or may not be interest bearing, and/or any combination thereof. It should be understood that these examples are non-limiting and account 212 may have features in addition to and/or other than those described herein.

According to another variation and as may be set forth by loan agreement 240, lender 110 may not fully fund the loan at closing, disbursing some amount less than the entire loan amount of $500M to borrower 120 at closing. For example, lender 110 may disburse/release to borrower 120 at closing a portion of the loan amount, which loan proceeds may be immediately accessible to/usable by borrower 120 (such proceeds may be referred to as the initial loan proceeds). Alternatively, lender 110 may disburse/release to borrower 120 at closing none of the loan amount for immediate use by borrower 120. Additionally, lender 110 may disburse/release to borrower 120 at closing a portion of, but not all of, the remaining loan amount, which loan proceeds may be not immediately accessible to/usable by the borrower (such proceeds may be referred to as the remaining loan proceeds). Alternatively, lender 110 may disburse/release to borrower 120 at closing none of the remaining loan amount. Again, in the former case if the portion of the remaining loan proceeds are not directly transferred to account 212, borrower 120 may be required to place/deposit (or have placed or deposited), for example, the loan proceeds into account 212. Thereafter, at one or more future times (e.g., after closing), lender 110 may disburse/release to borrower 120 additional portions of the remaining loan amount not yet disbursed/released, which loan proceeds borrower 120 may be required to place/deposit (or have placed/deposited) into account 212 but which again, are not immediately accessible to/usable by borrower 120. One or more criteria and/or milestones may be used to determine when such additional portions of the remaining loan amount (i.e., step 252) are disbursed/released to borrower 120. For example, additional portions of the remaining loan amount may be released to borrow 120: (a) as borrower 120 meets certain performance criteria regarding improvements to property 130 (e.g., ground breaking, defined amount of square feet built, defined number of floors built, defined improvements are met and signed off on by local, city, state, and/or third party inspector(s), etc.), (b) as borrower 120 meets certain financial and/or commercial targets, and/or (c) at predefined set dates, etc. It should be understood that these examples are non-limiting and other criteria/milestones in addition to and/or other than those described herein may be used.

One skilled in the art will also recognize that other and/or additional schemes to those discussed above may be used to disburse/release the loan amount from lender 110 to borrower 120. For example, in the variation where lender 110 may disburse/release to borrower 120 portions of the loan amount after closing, in addition to and/or alternatively to loan proceeds being placed into account 212, disbursed loan proceeds may be immediately accessible to/usable by borrower 120.

Returning to FIG. 2, regarding the loan proceeds deposited in account 212, at one or more future times (e.g., after closing) such proceeds may be disbursed/released from this account to borrower 120 (step 256) (or conversely, drawn by borrower 120 from account 212) pursuant to loan agreement 240, or in other words, made accessible to/usable by borrower 120. These loan proceeds may be used by borrower 120 to fund additional improvement/development expenses, for example, to property 130 in a manner set forth in the loan agreement. As discussed herein, approval by lender 110 may be required before loan proceeds are released from account 212 (or in other words, loan proceeds may be released to borrower 120 at the direction of lender 110). The total amount of loan proceeds disbursed/released from account 212 may not exceed the total amount of loan proceeds deposited in the account and similarly, does not necessarily need to be all of the loan proceeds deposited in the account. One or more criteria and/or milestones may be used to determine when loan proceeds are disbursed/released from account 212 to borrower 120/made accessible to borrower 120. For example, funds may be released to borrower 120: (a) as borrower 120 meets certain performance criteria regarding improvements to property 130 (e.g., obtaining of permits, ground breaking, defined amount of square feet built, defined number of floors built, defined improvements are met and signed off on by local, city, state, and/or third party inspector(s), etc.), (b) as borrower 120 meets certain financial and/or commercial targets, and/or (c) at predefined set dates, etc. It should be understood that these examples are non-limiting and other and/or additional criteria/milestones may be used. The performance criteria/milestones may be set forth by loan agreement 240, for example.

The amount of loan proceeds disbursed from account 212/made accessible to borrower 120 at step 256 may be based, for example, on expected expenses to be incurred by borrower 120 in making improvements to property 130 and/or expenses actually incurred by borrower 120 in making improvements to/developing property 130. For example, the loan proceeds disbursed funds from account 212 at any given time may be equal to, or a percentage of, expenses incurred by borrower 120, such as expenses incurred since a prior disbursement, expenses incurred in reaching a milestone, etc. As another example, the loan proceeds disbursed from the account may be pre-defined set amounts, as set forth by loan agreement 240 for example. As a further example, the loan proceeds disbursed from account 212 may be based on an algorithm as set forth by loan agreement 240. In addition to these examples, additional and/or other criteria for determining the amount of loan proceeds disbursed at any given time may be used. In a further aspect, regardless of what criteria/milestones are used to disburse loan proceeds from account 212 (if any at all), the disbursement/release of loan proceeds from account 212 may only occur at the direction/approval of lender 110 as discussed herein. For example, lender 110 may need to be satisfied that certain performance criteria and/or milestones have been met before proceeds are disbursed.

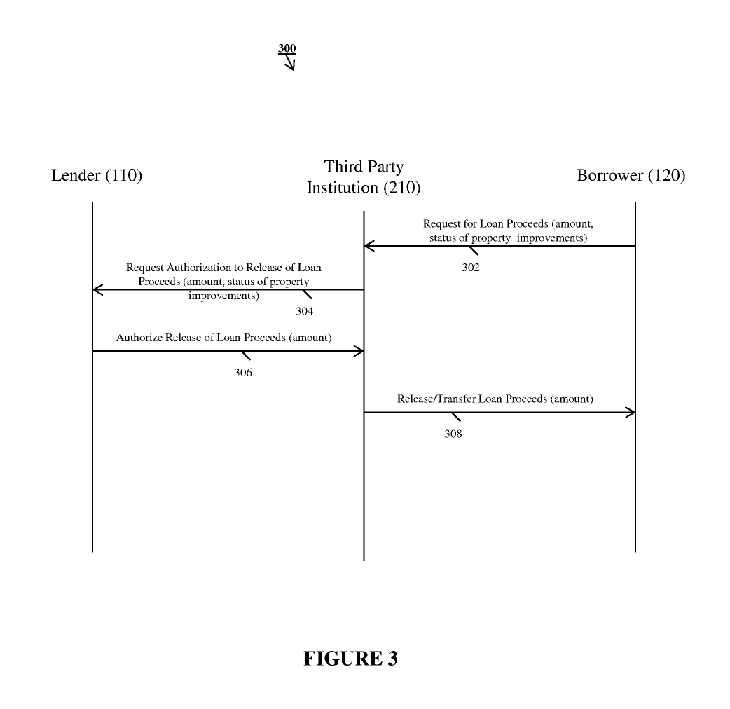

Referring to FIG. 3, there is shown an example process 300 by which loan proceeds may be disbursed/released from account 212 to borrower 120. This example process may also be referred to as a process by which borrower 120 may draw loan proceeds from account 212. At step 302, borrower 120 may make a request to third party institution 210 for loan proceeds to be disbursed/released from account 212 or in other words, may make a request to draw loan proceeds from the account. The request may include the amount of loan proceeds being requested for release. The request may also include information and/or data that show that one or more criteria/milestones have been met with respect to improvements to property 130, for example. Such information may include, for example, any one or more of: permit(s), receipts for services and/or items purchased, invoices for services and items yet to be paid for, reports/inspection reports signed off on by local, city, state, and/or third party inspector(s) (e.g., third party inspectors hired by lender 110), photo(s) of improvements to property 130, statements (e.g., bank statements) of one or more accounts (e.g., account 216) of borrower 120 showing any one or more of account levels, funds disbursed, etc., financial statements of borrower 120, reports from third party auditors of borrower 120's financials, etc. Other and/or additional information and data may be supplied and/or requested.

Upon receiving request 302, third party institution 210 may deny the request such as, for example, if it deems the request to be incomplete/missing information/data. Such a denial may be communicated by third party institution 210 to borrower 120 and may or may not include the reasons for the denial. Alternatively, at step 304, third party institution 210 may request from lender 110 authorization to release loan proceeds from account 212. This request may include the amount of loan proceeds being requested for release by borrower 120 and/or the information and/or data (or a portion thereof) provided by borrower 120 to third party institution 210.

Upon receiving request 304, lender 210 may deny the request such as, for example, if it deems the request to be incomplete/missing information/data, if it deems the amount of requested loan proceeds to be too high, if it deems that borrower 120 has not met one or more criteria/milestones, etc. Lender 110 may deny the request for other and/or additional reasons. Such a denial may be communicated by lender 110 to borrower 120 (directly or indirectly via third party institution 210) and may or may not include the reasons for the denial.

Alternatively, lender 120 may request additional information/data like that described herein from any one or more of borrower 120 and third party institution 210. As another alternative, at step 306 lender 110 may authorize third party institution 210 to release loan proceeds from account 212 to borrower 120 and the amount to be released. The amount of loan proceeds authorized for release may be equal to the amount requested by borrower 120. Alternatively, the amount of loan proceeds authorized for release may be more than or less than the amount requested by borrower 120. In response to receiving authorization, at step 308 third party institution may release/disburse loan proceeds from account 212 to borrower 120. Third party institution 210 may disburse/release the loan proceeds to borrower 120 by electronically transferring (or authorizing the electronic transfer of) the proceeds from account 212 to one or more accounts 216 of borrower 120 and/or to one or more accounts of third parties (such as parties to which borrower 120 may owe a payment(s)). Alternatively, third party institution 210 party institution 210 may disburse/release the loan proceeds to borrower 120 through one or more negotiable instruments (e.g., check). As another example, third party institution 210 may release the loan proceeds in account 212 without actually disbursing the proceeds but rather, allowing borrower 120 to withdraw the released proceeds as needed.

These examples are intended to be non-limiting and other and/or additional means than those described herein may be used to disburse loan proceeds to borrower 120 from account 212, including any combination of the above. One skilled in the art will also recognize that FIG. 3 is intended to be non-limiting and that other processes may be used. For example, rather than borrower 120 making a request 302 to third party institution 210, borrower 120 may make the request directly to lender 110. In response to receiving such a request, lender 110 may communicate authorization 306 to third party institution 210. As another example, lender 110 may request information/data, as discussed herein, from borrower 120. In response to receiving such information/data and determining that borrower 120 has met one or more milestones/criteria, for example, lender 110 may determine that loan proceeds may be released from account 212 and communicate authorization 306, for example, to third party institution 210, which may then release the loan proceeds to borrower 120 (step 308).

All aspects of FIG. 3 including communication between the parties and disbursement of loan proceeds from account 212 to borrower 120, for example, may occur via verbal and/or electronic communications between lender 110, borrower 120, and third party institution 210. With respect to electronic communications, one or more of lender 110, borrower 120, and third party institution 210 may each have a computer based system that allows the process shown of FIG. 3, for example, to occur via electronic communications. Such systems may be interconnected by one or more networks, including public and/or private networks and wired and/or wireless networks. Each system may include one or servers and databases. Each server may include one or more processors and one or more memories. Each system may also include one or more software based applications stored in one or more memories and/or one or more hardware based applications, which applications may be configured to perform and/or assist in the process of FIG. 3, for example. For example, one or more users associated/affiliated with lender 110, borrower 120, and/or third party institution 210 may initiate and/or receive electronically the communications of FIG. 3. As another example, one or more communications of FIG. 3 may not require human intervention, occurring via automated processes. For example, systems associated with third party institution 210 may automatically initiate request 304 in response to receiving request 302, may automatically release/transfer the loan proceeds in response to receiving authorization 306, etc. Again, one skilled in the art will recognize that other processes, both automated and manual, may be used to disburse/release loan proceeds from account 212 to borrower 120.

Returning again to FIG. 2, as shown loan agreement 240 may include several agreements (in paper and/or electronic form, for example) including, for example, one or more of promissory note 242, mortgage 244, completion guarantee 246, and account pledge 248. Note 242 may be executed by borrower 120 and made payable to lender 110 in the amount of $500M, for example. Note 242 may include, for example, an interest rate(s) and also a payment schedule(s) that sets forth when interest payment(s) and repayment(s) of the loan amount are due as discussed herein. The loan may be secured with a lien and/or security interest in property 130 and improvements thereto through mortgage agreement 244, which may made by borrower 120 for the benefit of lender 110. The loan may also be secured by an account pledge 248 to account 212. Borrower 120 may also issue for the benefit of lender 110 completion guarantee 246 and perform thereunder. It should be understood that these example agreements are non-limiting, and that other agreements different from and/or in addition to one or more of the agreements discussed herein is possible.

As discussed, in accordance with loan agreement 240, borrower 120 may need to make one or more interest payments to lender 110 until the loan amount is repaid, for example. As one example, borrower 120 may pay to lender 110 interest payments on the loan proceeds disbursed/released to borrower 120 at closing (i.e., disbursement 250) and on the loan proceeds disbursed/released from account 212 (i.e., disbursement 256). These interest payment(s) are shown as payments 258 in FIG. 2. Borrower 120 may also pay to lender 110 interest payments on the remaining loan proceeds in account 212, but not yet disbursed/released to borrower 120. These interest payment(s) are shown as payments 260 in FIG. 2. Each of interest payments 258 and 260 may be due at the same time and/or at different times, and may each be due multiple times per year and/or once a year, etc. In one example, the interest rate(s) associated with payments 258 (i.e., the interest rate on loan proceeds actually disbursed/released to borrower 120) may be higher than interest rate(s) associated with payments 260 (i.e., the interest rate on loan proceeds in account 212 but not yet disbursed/released to borrower 120). As another example, the two interest rates may be the same. As another example, the interest rate(s) associated with payments 258 may be lower than interest rate(s) associated with payments 260. It should be noted that the interest rate(s) associated with the payments discussed herein may either be floating and/or fixed interest rates. It should be understood that these examples are non-limiting, and that other interest payments different from and/or in addition to those discussed herein are possible. For example, borrower 120 may pay to lender 110 interest payments on the loan proceeds disbursed/released to borrower 120 at closing (i.e., disbursement 250) and on the loan proceeds disbursed/released from account 212 (i.e., disbursement 256). However, borrower 120 may not be obligated to pay to lender 110 any interest payments on the remaining loan proceeds in account 212 that are not yet disbursed/released to borrower 120.

Regarding the repayment of the loan amount as may be set forth by loan agreement 240, as one example, borrower 120 may not be obligated to begin repayment of the loan amount until the entire loan amount has been disbursed to the borrower, including the disbursement of all loan proceeds from account 212, or until borrower 120 no longer requires disbursements from account 212 (i.e., the entire amount borrowed from lender 120—e.g., $500M, is not needed by borrower 120). As another example, borrower 120 may not be obligated to begin repayment of the loan amount until borrower 120 meets a certain milestone/criteria, such as reaching a specified financial milestone, selling and/or leasing space in property 130, taking occupancy of property 130, etc. Such repayments may begin even though all loan proceeds have not been disbursed from account 212. One skilled in the art will recognize that regardless of when repayment begins, such repayment may occur over one or more years, for example. It should be understood that these examples are non-limiting, and additional and/or other structures may be used for repayment of the loan amount. One skilled in the art will also recognize that in the event borrower 120 does not require use of the entire amount borrowed from lender 120—e.g., $500M, and thereby does not require all loan proceeds be disbursed from account 212, such unused proceeds may be returned to lender 110 by borrower 120.

As similarly discussed herein, borrower 120 may make interest payments and/or repayment of the loan amount to lender 120 electronically, via negotiable instruments, etc.

According to a further aspect, borrower 120 may require loan proceeds in addition to the principal amount initially borrowed from lender 120 (i.e., additional proceeds above the $500M). As set forth by loan agreement 240, for example, lender 120 may loan additional loan proceeds to borrower 120, which proceeds may first be deposited into account 212 and withdrawn as discussed herein, and/or which proceeds may be disbursed to borrower 120 for immediate use.

According to a further aspect, lender 110 may sell the payment streams associated with interest payments 258 and/or 260. Lender 110 may also securitize the loan to borrower 120. For example, lender 110 may issue (directly, or indirectly) (privately or publically or any combination thereof) securities and/or other financial instruments to investors, which securities/instruments may be backed by/secured by mortgage 244 and/or account pledge 248. One skilled in the art will recognize that the loan to borrow 120 may be pooled with one or more additional assets including loans, for example, before being securitized. The issued securities/instruments may include debt securities, such as bonds. In general, such securities/instruments may be classified as mortgage backed securities. One skilled in the art will recognize that the loan may be securitized as any type of mortgage backed security. According to loan structure 200, lender 110 may securitize the entire loan amount following closing, for example, since the loan is fully funded at closing. One or more securities/financial instruments discussed herein may be issued/sold through one or more electronic systems/electronic exchanges and/or traded in a secondary market(s) through one or more electronic systems/electronic exchanges. Users of such exchanges (e.g., traders, brokers, etc.), may use electronic systems (such as computers, servers, laptops, phones, electronic pads, terminals, etc.) to interface with such electronic systems/electronic exchanges (such as over a network(s)) in order to submit orders (e.g., bids, offers, hits, takes, requests for quotes) (which orders may include quantities and/or prices) in order to buy and sell such securities/financial instruments and/or to view market (e.g., bids, offers, executed trades) related thereto as may be communicated by the electronic systems/electronic exchanges. Similarly, one or more securities/financial instruments discussed herein may be issued/sold through verbal communications and/or traded in a secondary market(s) through verbal communications. As another example, a combination of both electronic and verbal means may be used to issue and trade such securities/financial instruments. One skilled in the art will recognize that other variations are possible.

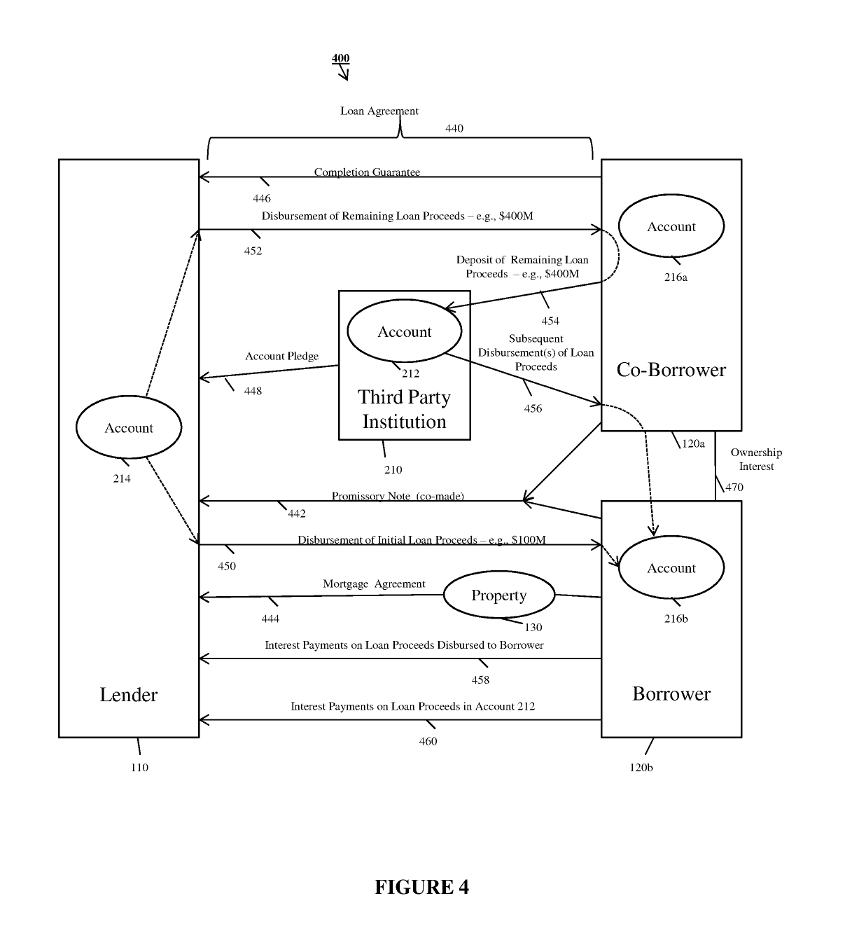

Referring to FIG. 4, there is shown another example loan structure 400, such as a construction loan, between multiple entities/parties. Example loan structure 400 is similar to example loan structure 200. For example, as discussed with reference to FIG. 2, a parent entity may create/use a sub-entity (borrower 120) to enter into a loan agreement with lender 110 for the purpose of improving/developing property 130. According to the example of FIG. 4, the parent entity (not shown in FIG. 4) may create/use multiple sub-entities, here co-borrower 120a and borrower 120b, for purposes of entering into a loan agreement with lender 110 and for the purpose of improving/developing property 130. As an example, the parent entity may form co-borrower 120a and/or borrower 120b for the purpose of developing/improving property 130 and as such, co-borrower 120a and/or borrower 120b may be newly formed entities for purposes of loan structure 400. Co-borrower 120a and borrower 120b may be special purpose entities and may be structured by the parent entity as limited liability companies that may be disregarded for tax purposes as entities distinct from the parent entity. It should be understood that these examples of co-borrower 120a and borrower 120b's structure are non-limiting, and additional and/or other structures may be used.

Co-Borrower 120a may own 100% of the equity in borrower 120b (as shown by 470), although it may own less or none at all. Co-borrower 120a may be prohibited from entering into any contracts related to the development of property 130 or from conducting any activities other than, for example, issuing and performing under completion guaranty 446 and maintaining account 212, as further discussed herein. Borrower 120b may lease or own (partially or fully) property 130 and be responsible for improvements to/development of property 130 including, for example, hiring all contractors necessary for improvement/development of property 130. It should be understood that these examples and features of co-borrower 120a and borrower 120b are non-limiting, and additional and/or other structures and features are possible.

According to the example of FIG. 4, lender 110 and co-borrower 120a/borrower 120b may enter into a loan/loan agreement 440 in which co-borrower 120a and borrower 120b may borrow a loan amount—e.g., $500M, from lender 110 (or conversely, in which lender 110 may loan proceeds to co-borrower 120a and borrower 120b). Again, such a loan agreement may be referred to as a construction loan agreement. According to one variation and as may be set forth by loan agreement 440 and as similarly discussed with reference to FIG. 2, lender 110 may fully fund the loan at closing, for example, disbursing/releasing the entire loan amount of $500M to co-borrower 120a and/or borrower 120b at closing. However, co-borrower 120a and/or borrower 120b may not have immediate access to/may not be able to immediately use any of or all of the loan proceeds to improve/develop property 130. According to this example, lender 110 may disburse/release to borrower 120b at closing a portion of the loan amount (step 450), such as an initial amount of $100M, which loan proceeds may be immediately accessible to/usable by borrower 120b (such proceeds may be referred to as the initial loan proceeds) (as similarly discussed herein, as another example, lender 110 may disburse/release to borrower 120b none of the loan amount for immediate use by borrower 120b). Borrower 120b may use the initial loan proceeds to fund improvement/development expenses to property 130, for example. In addition to the initial loan proceeds that lender 110 may disburse/release to borrower 120b at closing, lender 110 may also disburse/release to co-borrower 120a at closing the remaining loan amount, such as $400M (step 452), which loan proceeds may not be immediately accessible to/used by co-borrower 120a and/or borrower 120b (such proceeds may be referred to as the remaining loan proceeds). Rather co-borrower 120a may be required to place/deposit (or have placed/deposited), for example, the remaining loan proceeds into an account 212 (step 454). In this fashion and according to loan agreement 440, co-borrower 120a and borrower 120b may be jointly and severally liable for the loan amount. However, co-borrower 120a's liability may be capped at an amount equal to the remaining loan proceeds (e.g., $400 million) deposited into account 212, and in particular, may be further capped at an amount equal to the remaining loan proceeds minus all loan proceeds disbursed/released from account 212 (as shown by step 456). In the example of FIG. 4, account 212 may have similar features as discussed herein with reference to FIG. 2. In this example, however, co-borrower 120a may own account 212 and be responsible for maintaining the account. As similarly discussed for FIG. 2, one skilled in the art will recognize that these examples are non-limiting and that in addition to fully funding the loan at closing, other and/or additional variations are possible including not fully funding the loan at closing.

As similarly discussed with reference to loan structure 200 of FIG. 2, lender 110 may disburse/release the initial loan proceeds to borrower 120b in various fashions including, for example, by authorizing the electronic transfer of/electronically transferring the proceeds from one or more accounts 214 of the lender to one or more accounts 216b of borrower 120b. Similarly, lender 110 may disburse/release the remaining loan proceeds to co-borrower 120a in various fashions including, for example, by authorizing the electronic transfer of/electronically transferring the proceeds from one or more accounts 214 of the lender to account 212, or by authorizing the electronic transfer of the proceeds from one or more accounts 214 to one or more accounts 216a of co-borrower 120a. Again, in the latter case, co-borrower 120a may be required, once receiving the proceeds, to deposit the proceeds (e.g., by authorizing an electronic transfer or by depositing a negotiable instrument) into account 212 (step 454). As similarly discussed with reference to loan structure 200, other and/or additional means than those described herein may be used to disburse the initial loan proceeds and remaining loan proceeds to borrower 120b and co-borrower 120a, including any combination of the above.

Returning to FIG. 4, regarding the loan proceeds deposited in account 212, as similarly discussed with reference to loan structure 200 of FIG. 2, at one or more future times (e.g., after closing) such proceeds may be disbursed/released from this account to borrower 120b (step 456) (or conversely, drawn by borrower 120b from account 212) pursuant to loan agreement 440, or in other words, made accessible to/usable by borrower 120b. These loan proceeds may be used by borrower 120b to fund additional improvement/development expenses, for example, to property 130 in a manner set forth in the loan agreement. As discussed herein, the loan proceeds may be released by co-borrower 120a from account 212 to borrower 120b and in particular, may be released by co-borrower 120a from account 212 to borrower 120b at the approval/direction of lender 110. The total amount of loan proceeds disbursed/released from account 212 may not exceed the total amount of loan proceeds deposited in the account and similarly, does not necessarily need to be all of the loan proceeds deposited in the account.

As similarly discussed with reference to loan structure 200 of FIG. 2, one or more criteria and/or milestones may be used to determine when loan proceeds are disbursed/released from account 210 to borrower 120b/made accessible to borrower 120. Similarly, different criteria may be used to determine the amount of loan proceeds disbursed from account 212/made accessible to borrower 120b at any given time (e.g., amounts equal to expenses incurred by borrower 120b in making improvements to property 130).

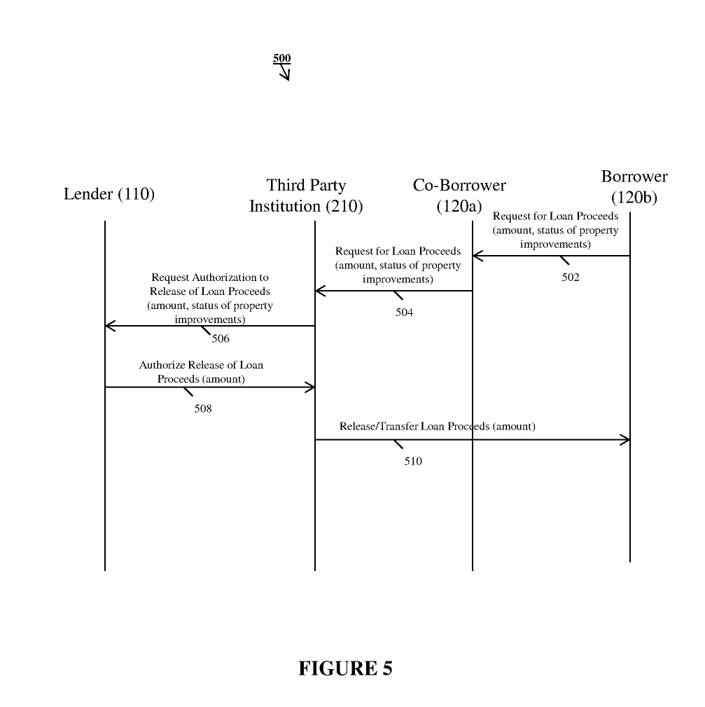

Referring to FIG. 5, there is shown an example process 500 by which loan proceeds may be disbursed/released from account 212 to borrower 120b. This example process may also be referred to as a process by which borrower 120b may draw loan proceeds from account 212. At step 502, borrower 120b may make a request to co-borrower 120a for loan proceeds. The request may include the amount of loan proceeds being requested for release, and also may include information and/or data that show that one or more criteria/milestones have been met with respect to improvements to property 130, as similarly discussed with respect to FIG. 3.

Upon receiving request 502, co-borrower 120a may deny the request such as, for example, if it deems the request to be incomplete/missing information/data. Such a denial may be communicated by co-borrower 120a to borrower 120b and may or may not include the reasons for the denial. Alternatively, at step 504, co-borrower 120a may make a request to third party institution 210 for loan proceeds to be disbursed/released from account 212 or in other words, may make a request to draw loan proceeds from the account. This request may include an amount of loan proceeds being requested for release, which amount may be equal to the amount requested by borrower 120b or alternatively, may be more than or less than the amount requested by borrower 120b. Request 504 may also include the information and/or data (or a portion thereof) provided by borrower 120b to co-borrower 120a and/or an analysis of the information/data by co-borrower 120a.

Upon receiving request 504, third party institution 210 may deny the request such as, for example, if it deems the request to be incomplete/missing information/data. Such a denial may be communicated by third party institution 210 to co-borrower 120a and/or borrower 120b (directly or indirectly via co-borrower 120a) and may or may not include the reasons for the denial. Alternatively, at step 506, third party institution 210 may request from lender 110 authorization to release loan proceeds from account 212. This request may include an amount of loan proceeds being requested for release, which amount may be equal to the amount requested by co-borrower 120a or alternatively, may be more than or less than the amount requested by co-borrower 120a. This request may also include information and/or data (or a portion thereof) provided by co-borrower 120a to third party institution 210.

Upon receiving request 506, lender 210 may deny the request such as, for example, if it deems the request to be incomplete/missing information/data, if it deems the amount of requested loan proceeds to be too high, if it deems that borrower 120b has not met one or more criteria/milestones, etc. Lender 110 may deny the request for other and/or additional reasons. Such a denial may be communicated by lender 110 to co-borrower 120a (directly or indirectly via third party institution 210) and/or borrower 120b (directly or indirectly via third party institution 210 and/or co-borrower 120a) and may or may not include the reasons for the denial. Alternatively, lender 120 may request additional information/data like that described herein from any one or more of co-borrower 120a, borrower 120b, and third party institution 210. As another alternative, at step 508 lender 110 may authorize third party institution 210 to release loan proceeds from account 212 to borrower 120 and the amount to be released.

In response to receiving authorization, at step 510 third party institution may release/disburse loan proceeds from account 212 to borrower 120b. Third party institution 210 may disburse/release the loan proceeds to borrower 120b by electronically transferring (or authorizing the electronic transfer of) the proceeds from account 212 to one or more accounts 216b of borrower 120b and/or to one or more accounts of third parties (such as parties to which borrower 120a may owe a payment(s)). Alternatively, third party institution 210 may disburse/release the loan proceeds to borrower 120b through one or more negotiable instruments (e.g., check). As another example, third party institution 210 may release the loan proceeds in account 212 without actually disbursing the proceeds but rather, allowing borrower 120b to withdraw the released proceeds as needed. As another example, in response to receiving authorization 508, at step 510 third party institution may release/disburse loan proceeds from account 212 to co-borrower 120a. Third party institution 210 may disburse/release the loan proceeds to co-borrower 120a by electronically transferring (or authorizing the electronic transfer of) the proceeds from account 212 to one or more accounts 216a of co-borrower 120a. Alternatively, third party institution 210 may disburse/release the loan proceeds to co-borrower 120a through one or more negotiable instruments (e.g., check). As another example, third party institution 210 may release the loan proceeds in account 212 without actually disbursing the proceeds but rather, allowing co-borrower 120a to withdraw the released proceeds as needed. In response to receiving the loan proceeds, co-borrower 120a may release/disburse the loan proceeds to borrower 120b. Co-borrower 120a may disburse/release the loan proceeds to borrower 120b by electronically transferring (or authorizing the electronic transfer of) the proceeds from account 216a to one or more accounts 216b of borrower 120b and/or to one or more accounts of third parties (such as parties to which borrower 120 may owe a payment(s), for example. Alternatively, co-borrower 120a may disburse/release the loan proceeds to borrower 120b through one or more negotiable instruments (e.g., check).

Again, these examples are intended to be non-limiting and other and/or additional means than those described herein may be used to disburse loan proceeds to borrower 120b from account 212, including any combination of the above. One skilled in the art will also recognize that FIG. 5 is intended to be non-limiting and that other processes may be used. For example, rather than borrower 120b making a request 502 to co-borrower 120a, borrower 120b may make the request to third party institution 210 and/or lender 110, with the process then proceeding as discussed herein. As another example, rather than co-borrower 120a making a request to third party institution 210, co-borrower 120a may make the request directly to lender 110, with the process then proceeding as discussed herein. As another example, lender 110 may request information/data, as discussed herein, from borrower 120b and/or co-borrower 120a. In response to receiving such information/data and determining that borrower 120a has met one or more milestones/criteria, for example, lender 110 may determine that loan proceeds may be released from account 212 and communicate authorization 508, for example, to third party institution 210, which may then release the loan proceeds in one or more fashions as discussed herein.

All aspects of FIG. 5 including communication between the parties and disbursement of loan proceeds from account 212 to borrower 120b, for example, may occur via verbal and/or electronic communications between lender 110, co-borrower 120a, borrower 120b, and third party institution 210. With respect to electronic communications, one or more of lender 110, co-borrower 120a, borrower 120b, and third party institution 210 may each have a computer based system, as similarly discussed with respect to FIG. 3, that allows the process shown of FIG. 5 to occur via electronic communications. For example, one or more users associated/affiliated with lender 110, co-borrower 120a, borrower 120b, and/or third party institution 210 may initiate and/or receive electronically the communications of FIG. 5. As another example, one or more communications of FIG. 5 may not require human intervention, occurring via automated processes. For example, systems associated with third party institution 210 may automatically initiate request 506 in response to receiving request 504, may automatically release/transfer the loan proceeds in response to receiving authorization 508, etc. Again, one skilled in the art will recognize that processes, both automated and manual, may be used to disburse/release loan proceeds from account 212 to borrower 120b.

Returning again to FIG. 4, loan agreement 440 may include several agreements (in paper and/or electronic form, for example) including, for example, one or more of promissory note 442, mortgage 444, completion guarantee 446, and account pledge 448. Note 442 may be co-made/executed by co-borrower 120a and borrower 120b, and made payable to lender 110 in the amount of the loan—$500M, for example. Note 442 may include, for example, an interest rate(s) and also a payment schedule(s) that sets forth when interest payment(s) and repayment(s) of the loan amount are due as discussed herein. The loan may be secured with a lien and/or security interest in property 130 and improvements thereto through mortgage agreement 444, which may made by borrower 120b for the benefit of lender 110. The loan may also be secured by an account pledge 448 to account 212, which may be made by co-borrower 120a for the benefit of lender 110. Co-borrower 120a may also issue for the benefit of lender 110 completion guarantee 446 and perform thereunder. It should be understood that these example agreements are non-limiting, and that other agreements different from and/or in addition to one or more of the agreements discussed herein is possible.

As discussed, in accordance with loan agreement 440, co-borrower 120a and/or borrower 120b may need to make one or more interest payments to lender 110 until the loan amount is repaid. As one example, borrower 120b may pay to lender 110 interest payments on the loan proceeds disbursed/released to borrower 120 at closing (i.e., disbursement 450) and on the loan proceeds disbursed/released from account 212 (i.e., disbursement 456). These interest payment(s) are shown as payments 458 in FIG. 4. Co-borrower 120a and/or borrower 120b (directly or indirectly through co-borrower 120a) may also pay to lender 110 interest payment(s) on the remaining loan proceeds in account 212, but not yet disbursed/released to borrower 120b. These interest payment(s) are shown as payments 460 in FIG. 4. Each of interest payments 458 and 460 may be due at the same time and/or at different times, and may each be due multiple times per year and/or once a year, etc. In one example, the interest rate(s) associated with payments 458 (i.e., the interest rate on loan proceeds actually disbursed/released to borrower 120b) may be higher than the interest rate(s) associated with payments 460 (i.e., the interest rate on loan proceeds in account 212 but not yet disbursed/released to borrower 120b). As another example, the two interest rates may be the same. As another example, the interest rate(s) associated with payments 460 may be higher than the interest rate(s) associated with payments 458. It should be noted that the interest rate(s) associated with the payments discussed herein may either be floating and/or fixed interest rates. It should be understood that these example are non-limiting, and that other interest payments different from and/or in addition those discussed herein are possible. For example, co-borrower 120a and/or borrower 120b may pay to lender 110 interest payments on the loan proceeds disbursed/released to borrower 120b at closing (i.e., disbursement 450) and on the loan proceeds disbursed/released from account 212 (i.e., disbursement 456). However, co-borrower 120a and/or borrower 120b may not be obligated to pay to lender 110 any interest payments on the remaining loan proceeds in account 212 that are not yet disbursed/released to borrower 120b.

Regarding the repayment of the loan amount as may be set forth by loan agreement 440, as one example, co-borrower 120a and/or borrower 120b may not be obligated to begin repayment of the loan amount until the entire loan amount has been disbursed to borrower 120b, including the disbursement of all loan proceeds from account 212, or until borrower 120b no longer requires disbursements from account 212 (i.e., the entire amount borrowed from lender 120—e.g., $500M, is not needed by borrower 120b). As another example, co-borrower 120a and/or borrower 120b may not be obligated to begin repayment of the loan amount until borrower 120b meets a certain milestone/criteria, such as reaching a specified financial milestone, selling and/or leasing space in property 130, taking occupancy of property 130, etc. Such repayments may begin even though all loan proceeds have not been disbursed from account 212. One skilled in the art will recognize that regardless of when repayment begins, such repayment may occur over one or more years, for example. It should be understood that these examples are non-limiting, and additional and/or other structures may be used for repayment of the loan amount. One skilled in the art will also recognize that in the event borrower 120b does not require use of the entire amount borrowed from lender 120—e.g., $500M, and thereby does not require all loan proceeds be disbursed from account 212, such unused proceeds may be returned to lender 110 by co-borrower 120a/borrower 120b.

As similarly discussed herein, co-borrower 120a and/or borrower 120b may make interest payments and/or repayment of the loan amount to lender 120 electronically, via negotiable instruments, etc.

According to a further aspect, co-borrower 120a and/or borrower 120b may require loan proceeds in addition to the principal amount initially borrowed from lender 120 (i.e., additional proceeds above the $500M). As set forth by loan agreement 440, for example, lender 120 may loan additional loan proceeds to co-borrower 120a and/or borrower 120b, which proceeds may first be deposited into account 212 and withdrawn as discussed herein, and/or which proceeds may be disbursed to borrower 120b for immediate use.

According to a further aspect, lender 110 may sell the payment streams associated with interest payments 458 and/or 460. Lender 110 may also securitize the loan to co-borrower 120a and borrower 120b. For example, lender 110 may issue (directly, or indirectly) (privately or publically or any combination thereof) securities and/or other financial instruments to investors, which securities/instruments may be backed by/secured by mortgage 444 and/or account pledge 448. One skilled in the art will recognize that the loan to co-borrower 120a and borrower 120b may be pooled with one or more additional assets including loans, for example, before being securitized. The issued securities/instruments may include debt securities, such as bonds. In general, such securities/instruments may be classified as mortgage backed securities. One skilled in the art will recognize that the loan may be securitized as any type of mortgage backed security. According to loan structure 400, lender 110 may securitize the entire loan amount following closing, for example, since the loan is fully funded at closing. One or more securities/financial instruments discussed herein may be issued/sold through one or more electronic systems/electronic exchanges and/or traded in a secondary market(s) through one or more electronic systems/electronic exchanges. Users of such exchanges (e.g., traders, brokers, etc.), may use electronic systems (such as computers, servers, laptops, phones, electronic pads, terminals, etc.) to interface with such electronic systems/electronic exchanges (such as over a network(s)) in order to submit orders (e.g., bids, offers, hits, takes, requests for quotes) (which orders may include quantities and/or prices) in order to buy and sell such securities/financial instruments and/or to view market (e.g., bids, offers, executed trades) related thereto as may be communicated by the electronic systems/electronic exchanges. Similarly, one or more securities/financial instruments discussed herein may be issued/sold through verbal communications and/or traded in a secondary market(s) through verbal communications. As another example, a combination of both electronic and verbal means may be used to issue and trade such securities/financial instruments. One skilled in the art will recognize that other variations are possible.

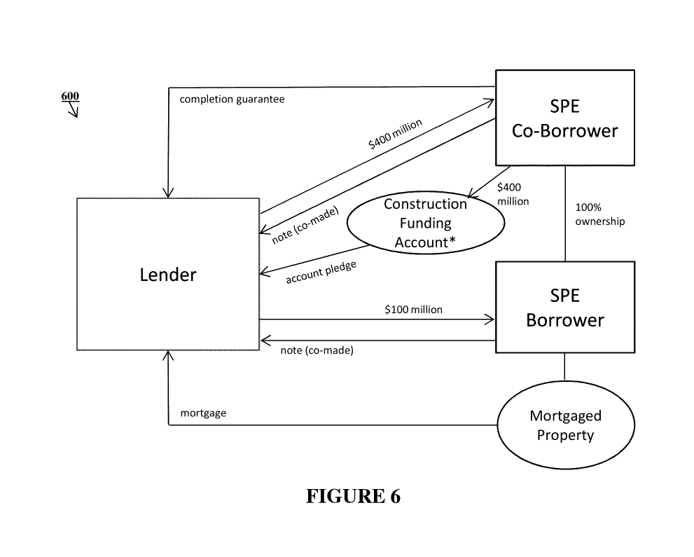

Referring to FIG. 6, there is shown another example loan structure 600 which may include one or more features and/or additional features of loan structures discussed herein.

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the claims herein.

The following sections provide a guide to interpreting the present application.

### I. Terms

The term “product” means a machine, manufacture and/or composition of matter, unless expressly specified otherwise.

The term “process” means a process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere description of a process, or in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the invention”, unless expressly specified otherwise.

The term “variation” of an invention means an embodiment of the invention, unless expressly specified otherwise.

The term “indication” is used in an extremely broad sense. An “indication” of a thing should be understood to include anything that may be used to determine the thing. An indication of a thing may include an electronic message that identifies the thing (e.g., an identification of a widget by a serial number affixed to the widget, an identification of a widget by one or more characteristics of the widget). An indication of a thing may include information that may be used to compute and/or look-up a thing (e.g., information identifying a machine of which a widget is a part that may be used to determine the widget). An indication of a thing may specify things that are related to the thing (e.g., characteristics of the thing, a name of the thing, a name of a thing related to the thing). An indication of a thing may not specify things that are related to the thing (e.g., a letter “a” may be an indication of a widget of a computer system that is configured to interpret the letter “a” to identify the widget). An indication of a thing may include a sign, a symptom, and/or a token of the thing. An indication, for example, may include a code, a reference, an example, a link, a signal, and/or an identifier. An indication of a thing may include information that represents, describes, and/or otherwise is associated with the thing.

A transformation of an indication of a thing may be an indication of the thing (e.g., an encrypted indication of a thing may be an indication of the thing). An indication of a thing may include the thing itself, a copy of the thing, and/or a portion of the thing. An indication of a thing may be meaningless to a thing that is not configured to understand the indication (e.g., a person may not understand that a letter “a” indicates a widget but it may nonetheless be an indication of the widget because the computer system may determine the widget from the letter “a”). It should be understood that the fact that an indication of a thing may be used to determine the thing does not mean that the thing or anything else is determined. An indication of a thing may include an indication of any number of the thing unless specified otherwise. An indication of a thing may include an indication of other things (e.g., an electronic message that indicates many things). (Indication can be used as a very broad term in claim language. For example: receiving an indication of a financial instrument.)

The term “represent” means (1) to serve to express, designate, stand for, or denote, as a word, symbol, or the like does; (2) to express or designate by some term, character, symbol, or the like; (3) to portray or depict or present the likeness of, as a picture does; or (4) to serve as a sign or symbol of.

A reference to “another embodiment” in describing an embodiment does not imply that the referenced embodiment is mutually exclusive with another embodiment (e.g., an embodiment described before the referenced embodiment), unless expressly specified otherwise. Similarly, the mere fact that two (or more) embodiments are referenced does not imply that those embodiments are mutually exclusive.

One embodiment of the invention may include or cover or embrace more than one other embodiment of the invention. For example, a first embodiment comprising elements a, b, and c may cover a second embodiment that comprises elements a, b, c, and d as well as a third embodiment covering elements a, b, c, and e. Similarly, each of the first, second, and third embodiments may cover a fourth embodiment comprising elements a, b, c, d, and e.

The terms “including”, “comprising” and variations thereof mean “including but not necessarily limited to”, unless expressly specified otherwise. Thus, for example, the sentence “the machine includes a red widget and a blue widget” means the machine includes the red widget and the blue widget, but may possibly include one or more other items as well.

The term “consisting of” and variations thereof mean “including and also limited to”, unless expressly specified otherwise. Thus, for example, the sentence “the machine consists of a red widget and a blue widget” means the machine includes the red widget and the blue widget, but does not include anything else.

The term “compose” and variations thereof mean “to make up the constituent parts of, component of or member of”, unless expressly specified otherwise. Thus, for example, the sentence “the red widget and the blue widget compose a machine” means the machine includes the red widget and the blue widget.

The term “exclusively compose” and variations thereof mean “to make up exclusively the constituent parts of, to be the only components of, or to be the only members of”, unless expressly specified otherwise. Thus, for example, the sentence “the red widget and the blue widget exclusively compose a machine” means the machine consists of the red widget and the blue widget (i.e. and nothing else).

The terms “a”, “an” and “the” refer to “one or more”, unless expressly specified otherwise. Thus, for example, the phrase “a widget” means one or more widgets, unless expressly specified otherwise. Similarly, after reciting the phrase “a widget”, a subsequent recitation of the phrase “the widget” means “the one or more widgets”. Accordingly, it should be understood that the word “the” may also refer to a specific term having antecedent basis. For example, if a paragraph mentions “a specific single feature” and then refers to “the feature,” then the phrase “the feature” should be understood to refer to the previously mentioned “a specific single feature.” (It should be understood that the term “a” in “a specific single feature” refers to “one” specific single feature and not “one or more” specific single features.)

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things. For example, the phrase “at least one of a widget, a car and a wheel” does not mean “one widget, one car and one wheel”.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” covers both “based only on” and “based at least on”. The phrase “based at least on” is equivalent to the phrase “based at least in part on”. For example, the phrase “element A is calculated based on element B and element C” covers embodiments where element A is calculated as the product of B times C (in other words, A=B×C), embodiments where A is calculated as the sum of B plus C (in other words, A=B+C), embodiments where A is calculated as a product of B times C times D, embodiments where A is calculated as a sum of the square root of B plus C plus D times E, and so on.

The term “represent” and like terms are not exclusive, unless expressly specified otherwise. For example, the term “represents” does not mean “represents only”, unless expressly specified otherwise. For example, the phrase “the data represents a credit card number” covers both “the data represents only a credit card number” and “the data represents a credit card number and the data also represents something else”.

The term “whereby” is used herein only to precede a clause or other set of words that express only the intended result, objective or consequence of something that is explicitly recited before the term “whereby”. Thus, when the term “whereby” is used in a claim, the clause or other words that the term “whereby” modifies do not establish specific further limitations of the claim or otherwise restrict the meaning or scope of the claim.

The terms “e.g.”, “such as” and like terms mean “for example”, and thus do not limit the term or phrase they explain. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first of the two machines has a function and the second of the two machines has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

A numerical range includes integers and non-integers in the range, unless expressly specified otherwise. For example, the range “1 to 10” includes the integers from 1 to 10 (e.g., 1, 2, 3, 4, . . . 9, 10) and non-integers (e.g., 1.0031415926, 1.1, 1.2, . . . 1.9).

Where two or more terms or phrases are synonymous (e.g., because of an explicit statement that the terms or phrases are synonymous), instances of one such term or phrase does not mean instances of another such term or phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

The term “determining” and grammatical variants thereof (e.g., to determine a price, determining a value, the determination of an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), rendering into electronic format or digital representation, ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing, averaging and the like.

The term “determining” does not imply that mathematical processing must be performed, and does not imply that numerical methods must be used, and does not imply that an algorithm is used.

The term “determining” does not imply that any particular device must be used. For example, a computer need not necessarily perform the determining.

The term “determining” may include “calculating”. The term “calculating” should be understood to include performing one or more calculations. Calculating may include computing, processing, and/or deriving. Calculating may be performed by a computing device. For example, calculating a thing may include applying an algorithm to data by a computer processor and generating the thing as an output of the processor.

The term “determining” may include “referencing”. The term “referencing” should be understood to include making one or more reference, e.g., to a thing. Referencing may include querying, accessing, selecting, choosing, reading, and/or looking-up. The act of referencing may be performed by a computing device. For example, referencing a thing may include reading a memory location in which the thing is stored by a processor.

The term “determining” may include “receiving”. For example, receiving a thing may include taking in the thing. In some embodiments, receiving may include acts performed to take in a thing, such as operating a network interface through which the thing is taken in. In some embodiments, receiving may be performed without acts performed to take in the thing, such as in a direct memory write or a hard wired circuit. Receiving a thing may include receiving a thing from a remote source that may have calculated the thing.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to that limitation (e.g., “the widget”), this mere usage does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term, but that ordinal number does not have any other meaning or limiting effect—it is merely a convenient name. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. The mere usage of ordinal numbers does not define a numerical limit to the features identified with the ordinal numbers. For example, the mere usage of the ordinal numbers “first” and “second” before the term “widget” does not indicate that there are exactly two widgets.

When a single device, article or other product is described herein, in another embodiment more than one device or article (whether or not they cooperate) may alternatively be used in place of the single device or article that is described. Accordingly, the functionality that is described as being possessed by a device may alternatively be possessed by more than one device or article (whether or not they cooperate) in another embodiment.

Similarly, where more than one device, article or other product is described herein (whether or not they cooperate), in another embodiment a single device or article may alternatively be used in place of the more than one device or article that is described. For example, a plurality of computer-based devices may be substituted with a single computer-based device. In some embodiments, such a plurality of computer-based devices may operate together to perform one step of a process such as is common in grid computing systems. In some embodiments, such a plurality of computer-based devices may operate provide added functionality to one another so that the plurality may operate to perform one step of a process such as is common in cloud computing systems. (Conversely, a single computer-based device may be substituted with multiple computer-based devices operating in cooperation with one another. For example, a single computing device may be substituted with a server and a workstation in communication with one another over the internet) Accordingly, the various functionality that is described as being possessed by more than one device or article may alternatively be possessed by a single device or article.

The functionality and/or the features of a single device that is described may, in another embodiment, be alternatively embodied by one or more other devices which are described but are not explicitly described as having such functionality or features. Thus, other embodiments need not include the described device itself, but rather can include the one or more other devices which would, in those other embodiments, have such functionality or features.

### IV. Disclosed Examples and Terminology are not Limiting

Neither the Title (set forth at the beginning of the first page of the present application) nor the Abstract (set forth at the end of the present application) is to be taken as limiting in any way the scope of the disclosed invention, is to be used in interpreting the meaning of any claim or is to be used in limiting the scope of any claim. An Abstract has been included in this application merely because an Abstract is required under 37 C.F.R. §1.72(b).

The headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The disclosed invention is widely applicable to numerous embodiments, as is readily apparent from the disclosure. One of ordinary skill in the art will recognize that the disclosed invention may be practiced with various modifications and alterations, such as structural, logical, software, and electrical modifications. Although particular features of the disclosed invention may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not be interpreted as requiring features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or (with respect to a claim and the invention defined by that claim) expressly recited in that claim.

Any preambles of the claims that recite anything other than a statutory class shall be interpreted to recite purposes, benefits and possible uses of the claimed invention, and such preambles shall not be construed to limit the claimed invention.

The present disclosure is not a literal description of all embodiments of the invention. Also, the present disclosure is not a listing of features of the invention which must be present in all embodiments.

All disclosed embodiments are not necessarily covered by the claims (even including all pending, amended, issued and canceled claims). In addition, a disclosed embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries. Devices are in communication with one another if they are capable of at least one-way communication with one another. For example, a first device is in communication with a second device if the first device is capable of transmitting information to the second device. Similarly, the second device is in communication with the first device if the second device is capable of receiving information from the first device.

A description of an embodiment with several components or features does not imply that all or even any of such components or features are required. On the contrary, a variety of optional components are described to illustrate the wide variety of possible embodiments of the present invention. Unless otherwise specified explicitly, no component or feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are preferred, essential or required. Various other embodiments within the scope of the described invention include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, and a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

The term “compute” shall mean to determine using a processor in accordance with a software algorithm.

A “processor” means one or more microprocessors, central processing units (CPUs), computing devices, microcontrollers, digital signal processors, graphics processing units (GPUs) or like devices or any combination thereof, regardless of the architecture (e.g., chip-level multiprocessing or multi-core, RISC, CISC, Microprocessor without Interlocked Pipeline Stages, pipelining configuration, simultaneous multithreading, microprocessor with integrated graphics processing unit, GPGPU).

A “computing device” means one or more microprocessors, central processing units (CPUs), computing devices, microcontrollers, digital signal processors, graphics card, mobile gaming device, or like devices or any combination thereof, regardless of the architecture (e.g., chip-level multiprocessing or multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process. For example, a description of a process is a description of an apparatus comprising a processor and memory that stores a program comprising instructions that, when executed by the processor, direct the processor to perform the method.

The apparatus that performs the process can include a plurality of computing devices that work together to perform the process. Some of the computing devices may work together to perform each step of a process, may work on separate steps of a process, may provide underlying services that other computing devices that may facilitate the performance of the process. Such computing devices may act under instruction of a centralized authority. In another embodiment, such computing devices may act without instruction of a centralized authority. Some examples of apparatus that may operate in some or all of these ways may include grid computer systems, cloud computer systems, peer-to-peer computer systems, computer systems configured to provide software as a service, and so on. For example, the apparatus may comprise a computer system that executes the bulk of its processing load on a remote server but outputs display information to and receives user input information from a local user computer, such as a computer system that executes VMware software.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any non-transitory medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

The term “tangible computer-readable medium” refers to a “computer-readable medium” that comprises a hardware component, such as optical or magnetic disks.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), wireless local area network communication defined by the IEEE 802.11 specifications whether or not they are approved by the WiFi Alliance, SAP, ATP, Bluetooth™, and TCP/IP, TDMA, CDMA, and 3G; and/or (iv) encrypted to ensure privacy or prevent fraud in any of a variety of ways well known in the art.

The term “database” refers to any electronically-stored collection of data that is stored in a retrievable format.

The term “data structure” refers to a database in a hardware machine such as a computer.

The term “network” means a series of points or nodes interconnected by communication paths. For example, a network can include a plurality of computers or communication devices interconnected by one or more wired and/or wireless communication paths. Networks can interconnect with other networks and contain subnetworks.

The term “predetermined” means determined beforehand, e.g., before a present time or a present action. For example, the phrase “displaying a predetermined value” means displaying a value that was determined before the act of displaying.

The term “condition” means (1) a premise upon which the fulfillment of an agreement depends, or (2) something essential to the appearance or occurrence of something else.

The term “transaction” means (1) an exchange or transfer of goods, services, or funds, or (2) a communicative action or activity involving two parties or things that reciprocally affect or influence each other.

Thus a description of a process is likewise a description of a computer-readable medium storing a program for performing the process. The computer-readable medium can store (in any appropriate format) those program elements which are appropriate to perform the method. For example, a description of a process is a description of a computer-readable storage medium that stores a program comprising instructions that, when executed by a processor, direct the processor to perform the method.

Just as the description of various steps in a process does not indicate that all the described steps are required, embodiments of an apparatus include a computer or computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel®, Pentium®, or Centrino™, Atom™ or Core™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As used herein, the term “encryption” refers to a process for obscuring or hiding information so that the information is not readily understandable without special knowledge. The process of encryption may transform raw information, called plaintext, into encrypted information. The encrypted information may be called ciphertext, and the algorithm for transforming the plaintext into ciphertext may be referred to as a cipher. A cipher may also be used for performing the reverse operation of converting the ciphertext back into plaintext. Examples of ciphers include substitution ciphers, transposition ciphers, and ciphers implemented using rotor machines.

In various encryption methods, ciphers may require a supplementary piece of information called a key. A key may consist, for example, of a string of bits. A key may be used in conjunction with a cipher to encrypt plaintext. A key may also be used in conjunction with a cipher to decrypt ciphertext. In a category of ciphers called symmetric key algorithms (e.g., private-key cryptography), the same key is used for both encryption and decryption. The sanctity of the encrypted information may thus depend on the key being kept secret. Examples of symmetric key algorithms are DES and AES. In a category of ciphers called asymmetric key algorithms (e.g., public-key cryptography), different keys are used for encryption and decryption. With an asymmetric key algorithm, any member of the public may use a first key (e.g., a public key) to encrypt plaintext into ciphertext. However, only the holder of a second key (e.g., the private key) will be able to decrypt the ciphertext back in to plaintext. An example of an asymmetric key algorithm is the RSA algorithm.

### VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VII. 35 U.S.C. §112, Paragraph 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application will be prefaced by the phrase “does not include” or by the phrase “cannot perform”.

### IX. Incorporation By Reference

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference. Conversely, the definitions provided in this application should not be used to limit, define, or otherwise construe any term of any document incorporated herein by reference. The definitions set forth explicitly in this application are controlling notwithstanding the description of particular embodiments that may be incompatible with the definition(s).

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art refers to the prosecution history of the present application, but not to the prosecution history of any other patent or patent application, regardless of whether there are other patent applications that are considered related to the present application, and regardless of whether there are other patent applications that share a claim of priority with the present application.

What is claimed is:

1. A method comprising:
entering into by a lender a loan agreement with a borrower, wherein the lender loans a loan amount to the borrower; and
fully funding by the lender the loan at closing, including:
electronically transferring a first portion of the loan amount to at least a first account of the borrower; and
electronically transferring a second portion of the loan amount to at least a second account of the borrower,
wherein the first portion and the second portion to the loan amount,
wherein the first portion is immediately accessible to the borrower for use by the borrower, and
wherein the second portion is accessible to the borrower upon authorization from the lender.

2. The method of claim 1, further comprising securitizing the entire loan amount following closing.

3. The method of claim 1, further comprising:
receiving by a computing system of the lender, at at least one time after closing, a request for authorization to release at least a portion of the second amount to the borrower; and
based at least in part on the request, communicating by the computing system an authorization to release to the borrower at least a portion of the second amount, wherein the authorization results in an electronic transfer of the at least portion from the at least second account to another account of the borrower.

4. The method of claim 1, wherein the loan amount is secured, at least in part, by a security interest in real property.

5. The method of claim 4, wherein the loan is further secured by an account pledge to the second account.

6. The method of claim 1, further comprising receiving by the lender:
at least one interest payment associated with the first amount, and
at least one interest payment associated with the first amount.

7. The method of claim 6, where an interest rate associated with the first amount is higher than an interest rate associated with the second amount.

8. The method of claim 6, further comprising selling a payment stream associated with at least one of:
the at least one interest payment associated with the first amount, and
the at least one interest payment associated with the first amount.

9. The method of claim 8, further comprising securitizing the entire loan amount following closing.

10. The method of claim 1:
wherein the loan agreement is for development of real property;
wherein the borrower comprises at least a first and a second entity, wherein the first entity owns the real property and the second entity owns the first entity;
wherein the first portion is disbursed to the first entity; and
wherein the second portion is disbursed to the second entity.

11. The method of claim 10, wherein the loan amount is secured, at least in part, by a security interest in the real property and by an account pledge to the second account.

12. The method of claim 10, further comprising receiving by the lender:
at least one interest payment associated with the first amount, and
at least one interest payment associated with the first amount.

13. The method of claim 12, where an interest rate associated with the first amount is higher than an interest rate associated with the second amount.

14. The method of claim 1, further comprising:
receiving by a computing system of the lender, at at least one time after closing, a request for authorization to release at least a portion of the second amount; and
based at least in part on the request, communicating by the computing system an authorization to release at least a portion of the second amount, wherein the authorization results in an electronic transfer of the at least portion from the at least second account to another account of the first or second entity.
